(19) United States
(12) Patent Application Publication
(10) Pub. No.: US 2010/0174656 A1
(43) Pub. Date: Jul. 8, 2010

(54) System And Method For Coordinating Building And Construction Activities

(76) Inventor: Justin Humphrey Nolan, New York, NY (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 12/503,055

(22) Filed: Jul. 14, 2009

Related U.S. Application Data
(60) Provisional application No. 61/080,745, filed on Jul. 15, 2008.

(51) Int. Cl. G06Q 10/00; G06Q 50/00; G06F 15/16

(52) U.S. Cl. 705/301; 705/313; 709/204; 705/7; 705/8

(57) ABSTRACT

A computer based system and method for coordinating building and construction activities that allows electronic punchlists to be created, updated, and managed remotely using a handheld device or a computer with access to the internet. The system and method allows for complete control in the field. The electronic punchlists may also be mapped to electronic blueprints for ease of navigation through multiple punchlists and tasks. Additional information such as digital media, change orders, issues, scheduling, specifications, contracts, and requests for information may also be mapped to the electronic punchlists. The punchlist data may also be used to generate reports.

### CROSS-REFERENCE TO RELATED PATENT APPLICATIONS

This application claims the benefit of the filing date of U.S. Provisional patent application Ser. No. 61/080,745 filed on Jul. 15, 2008.

### BACKGROUND OF THE INVENTION

1. Field of the Invention

The present invention relates to project management systems, and more particularly, relates to a system and method for coordinating building and construction activities.

2. Description of Related Art

Construction and building projects are controlled and managed using various forms of documentation including blueprints, punchlists, project schedules, reports, contracts, change orders, specifications, and the like. Efficient access to project management information conveyed on this documentation is important for the quality, profitability and success of a project.

Unfortunately, many construction and building projects use notes to do lists, paper schedules, and schedules prepared by different contractors or subcontractors. This disparity of information causes contusion, rework, lost productivity, and other related maladies.

There exists an unmet need for an electronic system that integrates punchlists, change orders, visual information, specifications, contracts, schedules, reports and issues with blueprint navigation, and allows access, updates and management through remote handheld devices in addition to traditional computers.

It is an object of the present invention to provide a computer based system for creating and managing electronic punchlists. It is another object of the present invention to provide a computer based system for mapping electronic punchlists to electronic blueprints. It is another object of the present invention to provide a computer based system for creating and managing electronic punchlists from multiple locations. It is another object of the present invention to provide a computer based system for mapping digital media to electronic punchlists. It is another object of the present invention to provide a computer based system for transferring electronic punchlist data into reports. It is yet another object of the present invention to provide a computer based system that maps punchlist data between electronic devices.

These and other objects of the present invention are described in the detailed specification, drawings and claims contained herein.

### BRIEF SUMMARY OF INVENTION

In accordance with the present invention there is provided a computer based system and method for coordinating building and construction activities comprising a server having a punchlist module for creating and managing electronic punchlists, at least one handheld device having a mobile punchlist module, and a connection between the server and at least one handheld device for data transfer between the server and at least one handheld device.

The foregoing paragraph has been provided by way of introduction, and is not intended to limit the scope of the invention as described herein.

### BRIEF DESCRIPTION THE DRAWINGS

The invention will be described by reference to the following drawings, in which like numerals refer to like elements, and in which:

FIG. 1 is a functional block diagram depicting the various components of the system for coordinating building and construction activities;

FIG. 2 is an exemplary network diagram of the system for coordinating building and construction activities;

FIG. 3 is a functional diagram of the system for coordinating building and construction activities;

FIG. 4 is a diagram showing data flow within a geographically disperse system;

FIG. 5 is a diagram depicting handheld wireless sync;

FIG. 6 is a flowchart showing punchlist and blueprint interaction;

FIG. 7 is a flowchart showing the progression of updates within the system;

FIG. 8 is a screenshot of an exemplary main page of the mobile punchlist module;

FIG. 9 is a screenshot of an exemplary list of the mobile punchlist module;

FIG. 10 is a screenshot of an exemplary items list of the mobile punchlist module;

FIG. 11 is screenshot example of adding an item in the mobile punchlist module;

FIG. 12 is a screenshot of the bottom of the screen in FIG. 11;

FIGS. 13-16 depict screenshots of editing a punchlist item in the mobile punchlist module;

FIG. 17 is a screenshot of an exemplary web page of punchlist items in the punchlist module;

FIG. 18 is a screenshot of an exemplary web page of a punchlist item having a digital image in the punchlist module;

FIG. 19 is a screenshot of the bottom of the screen in FIG. 18;

FIG. 20 is a screenshot of an exemplary main page of the mobile punchlist module showing access to daily reports;

FIG. 21 is a screenshot of an exemplary daily report task list or the mobile punchlist module;

FIG. 22 is a screenshot of an exemplary daily report main page of the mobile punchlist module;

FIG. 23 is a screenshot example of adding a daily report task;

FIG. 24 is a screenshot of the bottom of the screen in FIG. 23;

FIG. 25 is a screenshot of an exemplary daily report task list of the mobile punchlist module;

FIG. 26 is a screenshot of an exemplary daily report main page of the mobile punchlist module;

FIG. 27 is a screenshot example of editing a daily report task;

FIG. 28 is a screenshot of the bottom of the screen in FIG. 27;

FIG. 29 is a screenshot depicting blueprint navigation in the mobile blueprint navigation module;

FIG. 30 is a screenshot depicting blueprint navigation with flags in the mobile blueprint navigation module;

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, drawings, and claims contained herein.

### DESCRIPTION OF THE PREFERRED EMBODIMENTS

A portion of the disclosure of this patent document contains material which is subject to copyright protection. The copyright owner has no objection to the facsimile reproduction by anyone of the patent document to the patent disclosure, as it appear appears in the Patent and Trademark Office patent files or records, but otherwise reserves all copyrights whatsoever.

For a general understanding of the present invention, reference is made to the drawings. In the drawings, like reference numerals have been used throughout to designate identical elements.

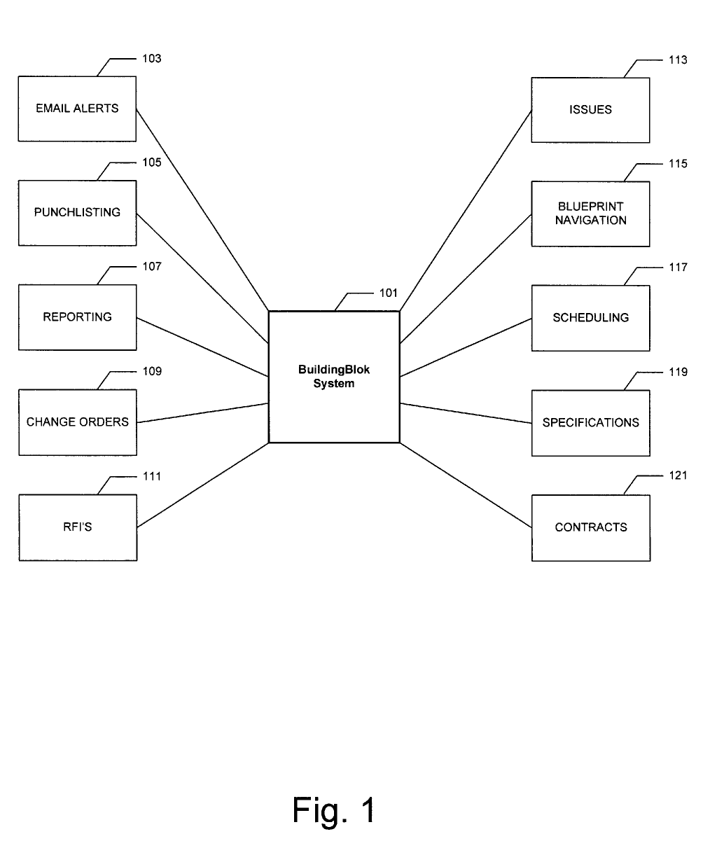

FIG. 1 is a functional block diagram depicting the various components of the system for coordinating building and construction activities. Referring to FIG. 1, the system for coordinating building and construction activities 101, also referred to in this specification as the BuildingBlok system, contains various components. The components depicted in FIG. 1 are representative only, and omissions and substitutions of these exemplary components may be performed without departing from the spirit and broad scope of the present invention and its various embodiments described and illustrated herein.

Electronic punchlisting 105 makes up one of the base modules of the present invention. Electronic punchlisting 105 is performed by a punchlist module resident on at server and or a mobile. Each punchlist contains a listing of punchlist items, which items that require attention in a construction project. Each punchlist item may contain a status indicator, a description, a project name, notes, digital media such as digital photographs, an assigned to name, and the like.

Reporting 107 is another module of the system for coordinating building and construction activities. Punchlist items, and the information associated with each punchlist item, is formatted into reports that may be accessed and updated through a wireless device or a computer connected to the internet.

An email alerts module 103 can initiate emails based on specified criteria such as newly created punchlist items, punchlist items that are past their due date, and the like.

A Change orders module 109 provides for electronic entry and management of la change orders in the system 101. A change order is a request to deviate or modify a planned task in a construction project.

A request for information module 111 provides for electronic entry and management of requests for information in the system 101. A request for information relates to a transmittal asking for cost and other specifics before or during a construction project.

An issues module 113 provides for electronic entry and management of issues in the system 101. Issues may be entered manually or the information may be taken from previously entered punchlist information. The issues module provides the ability to create issues (construction forms and the like) as well as update them on a handheld device.

A blueprint navigation module 115 provides for the loading and display of electronic blueprints. Punch lists may be tagged to a location on an electronic blueprint using a punchlist overlay module of the present invention.

A scheduling module 117 is provided within the system 101. Specific tasks and punchlist items may be placed on a calendar or a similar display that indicates the time and progress of certain activities.

A specifications module 119 provides for fix electronic entry and management of specifications in the system 101. Specifications include, for example, written requirements for materials and work to be performed.

A contracts module 121 provides for electronic entry and management of contracts in the system 101. Contracts may be between the client and the prime contractor, the prime contractor and subcontractors, the prime contractor and suppliers, and the like.

It should be noted that the architecture of the system of the present invention includes both a server and handheld devices, and the modules described herein are functional on both the server or servers as well as handheld devices and related computing appliances.

Further details related to these components will be provided in later parts of this specification, and will be made clear by way of screenshots provided in the drawings.

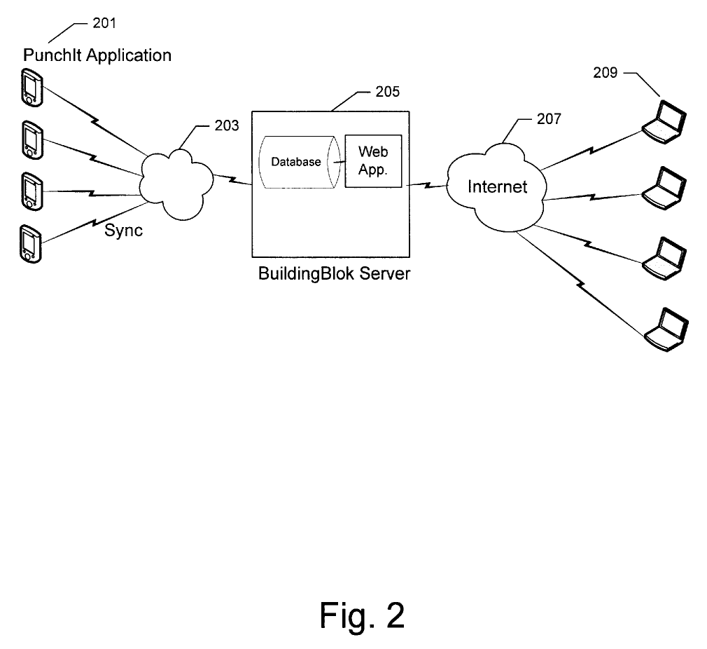

Turning now to FIG. 2, an exemplary network diagram of the system for coordinating building and construction activities is depicted. The BuildingBlok server 205 contains a database, databases, or a similar data retention entity. The database contains information related to each punchlist. Other data may also be present depending on the selection of functions to be used. Data may be related to reports, change orders, requests for information, issues, blueprints and blueprint navigation, scheduling, specifications, contracts, and the like. A web application (Web App.) provides front end user presentation, and controls such things as punchlist layout and graphics, report presentation, selection criteria, user interface and control, and the like. Such a web system is part of the server. The ability to create, manage, update and control punchlists and perform other functions from the field is done by way of the PunchIt Application that resides on a handheld device 201 such as, for example, an Apple iPhone®, RIM Blackberry®, Palm Treo®, or the like. Connectivity to the BuildingBlok server 205 is done by way of a wireless connection 203 such as the cellular network, WiFi network, or the like. Connectivity may include a combination of wired, wireless, or optical transmission paths. The ability to create, manage, update and control punchlists and perform other functions may also be performed by way of a computer 209 connected through the internet 207 to the BuildingBlok Server 205.

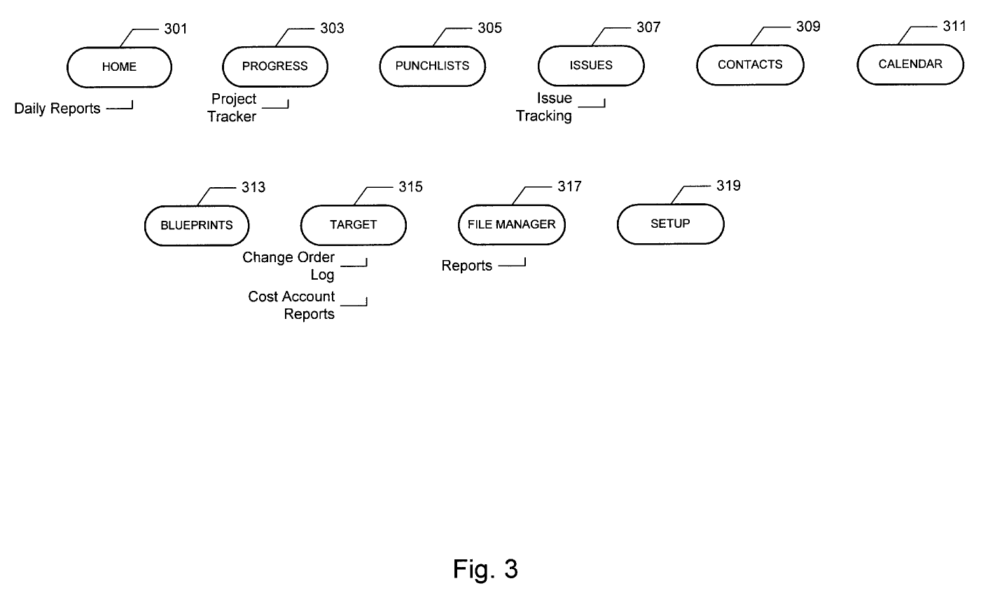

FIG. 3 is a functional diagram of the system for coordinating building and construction activities. Various embodiments of the present invention may use some or all of the functions depicted in FIG. 3. The functions may be implemented by way of a web site or the like. The functions described by way of FIG. 3 will be further described later in this specification. A home function 301 contains general information that is useful in using and managing the system. The home function 301 may also include daily reports that provide a. snapshot of work being performed for a building or construction project, as well as a list of recent activity for a project, and listings of problems, delays and alerts for a project. A progress function 303 contains a project tracker that provides the user with a pert or gantt chart related to the construction or building project, or similar calendar function. The project tracker provides status of tasks that indicate whether the task is complete, in progress, delayed, or not started. The punchlists are contained in a punchlist function 305 that may also be tagged to a blueprint location. Punchlists can be created, renamed, deleted, and assigned. An issues function 307 provides the user with issues related to the building or construction project, type of issue, status of each issue, who each issue is assigned to, date that the issue was opened, priority of the issue, when the issue was created, updated, due, and other related metrics. A contacts function 309 provides contacts for a project including first and last name, company, project permissions, project role, primary phone, internal (system) email and external email, and further information that may be related to the contacts for a project. A calendar function 311 allows for a graphical representation of selected events and activities. Calendars can include critical construction tasks, construction tasks, public calendar. My calendar, and the like. Calendar data can be imported and exported as XML data or other common formats. In the blueprint function 313, blueprints related to a construction or building project are displayed, and may be listed by title, date, revision, and similar criteria. Blueprints can be uploaded and added as required by the project. A target function 315 provides such information as change order logs, cost account reports, and the like. A file manager function 317 provides reports that are relevant to the building or construction project, and may include recent files such as daily reports. A setup function 319 allows a user to enter information such as the project name, project location, project address, project photo, company name, project type, and the like. In addition, main contacts can be entered, including owner, manager, architect, operation manager, accountant, foreman, and the like. Information such as name and address of subcontractors can also be entered. Cost groups can also be entered, as well as contracts and definitions of change order types.

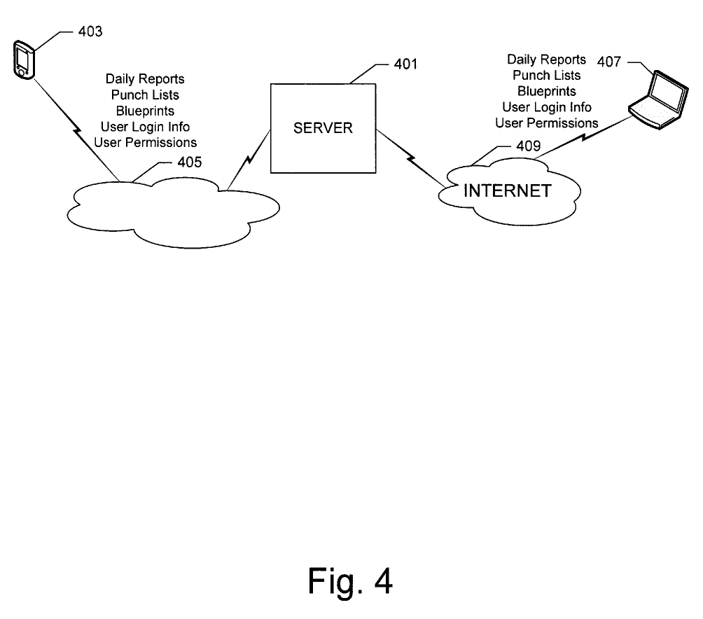

Now turning to FIG. 4, a diagram showing data flow within a geographically disperse system is shown. The BuildingBlok server 401 can be connected to by way of a handheld device 403 or a computer 407. Connectivity from the handheld device 403 to the BuildingBlok server 401 is by way of a wireless network 405 that may also include segments of wired networks, optical networks, and the like. Connectivity from the computer 407 to the BuildingBlok server 401 is by way of the internet 409. The system for coordinating building and construction activities of the present invention allows for complete remote management using either a handheld device 403 or a computer 407. Data contained, in daily reports, punch lists, blueprints, as well as user login information and user permissions, is transferred back and forth between the BuildingBlok server 401 and what is often times a plurality of handheld devices 403 and computers 407. Updates made from the field using a handheld device 403, for example, are transferred to the BuildingBlok server 401 such that other handheld devices and computers are provided with the updated information. A hierarchy of user permissions can be established to allow certain classes of users to access or update information, and to prevent access or updates by other users.

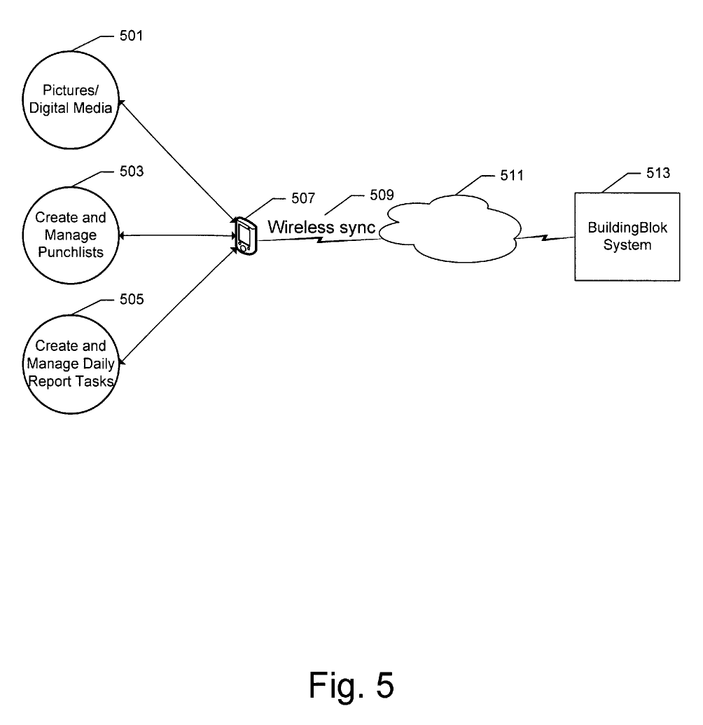

FIG. 5 is a diagram depicting handheld wireless sync. A handheld device 507 is shown connected to the BuildingBlok System 513 by way of a network 511. The network 511 may be wireless, and may include segments of wired or optical networks as well. Wireless sync 509 is as function that allows data updates resident on either as handheld device, computer, or the BuildingBlok server, to be transferred to other components in the system. For example, an update to a punchlist that has been made in the field is transferred to the BuildingBlok server by way of the wireless sync function, and updates to other handheld devices and computers assigned to the specific project are made using wireless sync. The handheld device 507 allows a user to create and manage punchlists 503, create and manage daily report tasks 505, and also capture and manage pictures and digital media 501. Digital media may include photographs, videos, audio recordings and audio notes, as well as speech to text conversion.

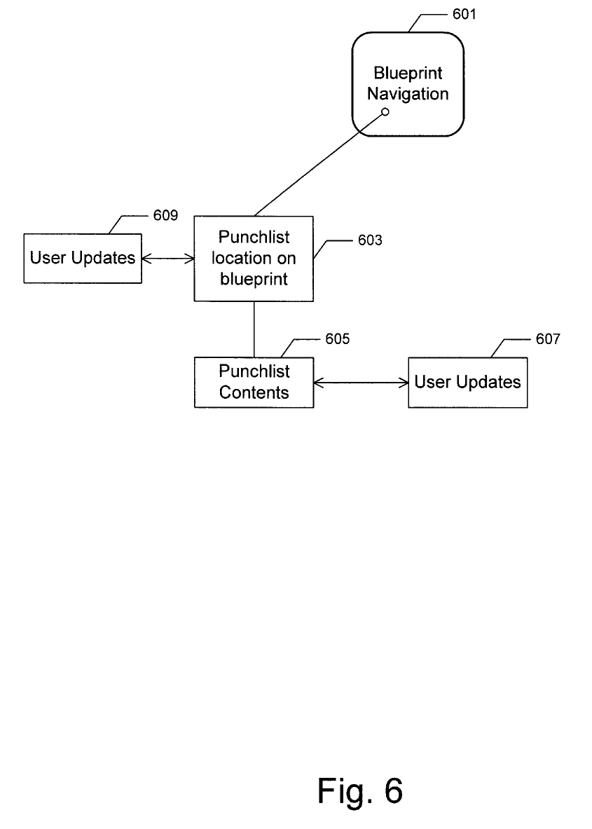

When managing large construction or building projects, many punchlists are used. Keeping track of a myriad of punchlists is a large task unto itself. The system of the present invention allows electronic tagging of a punchlist to a location on an electronic blueprint. FIG. 6 is a flowchart showing punchlist and blueprint interaction. Such interaction is performed by way of a punchlist overlay module that is coupled to both the punchlist module and the blueprint navigation module. The interaction, as depicted in FIG. 6, tags a punchlist in the punchlist module to a location on an electronic blueprint contained in the blueprint navigation module. The punchlist overlay module is coupled to both the punchlist module and the blueprint navigation module. The punchlist overlay module functions in both the server and related internet environment as well as the mobile electronic device environment. Blueprint navigation 601 allows a user to move around in a series of electronic blueprints. An electronic designator is provided that gives a graphical indication at a specific location on the electronic blueprint that a punchlist is present for that location, the punchlist location on the blueprint 603 providing an indication of where the punchlist contents 605 contained in the referenced punchlist are located. Further status indicators are provided on the blueprint. The punch list location on the blueprint 603 is subject to user updates 609 by way of a handheld device or computer. The Punchlist contents 605 are also subject to user updates 607. Taking an action, such as clicking on the graphical indicator, will, open up the target punchlist, thus saving time and creating process efficiencies.

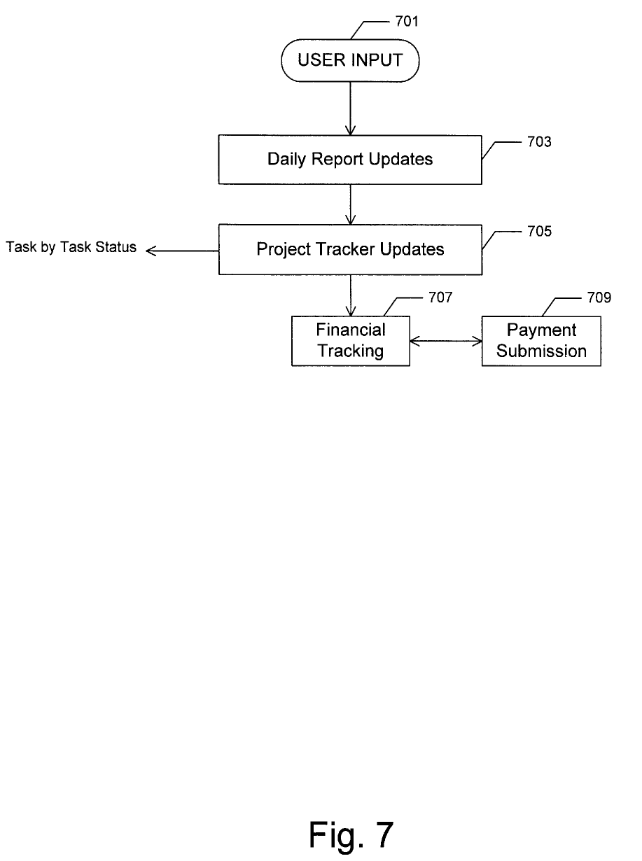

FIG. 7 is a flowchart showing the progression of updates within the system. Typically, updates start with user input 701 that may be provided through a handheld device or a computer, for example. Daily report updates 703 are made using user input 701, which are then used for Project Tracker updates 705. The Project Tracker updates 705 can be used to generate a task by task status. Project Tracker updates 705 also feed Financial Tracking 707. When payment submission 709 occurs, financial tracking 707 is updated. Updates can also occur within the Punch lists (not shown), and then feed Daily Report Updates 703.

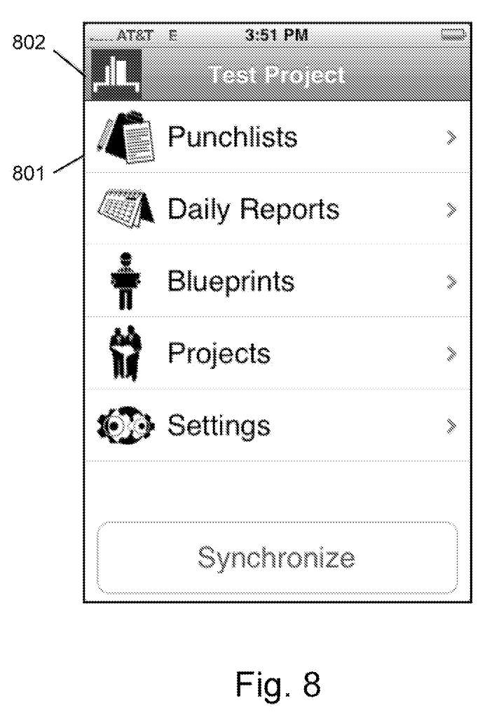

The following FIGS. 8-30 depict various screen shots of the system and method of coordinating building and construction activities. Variations of the screen format, layout, data fields, icons, menus, and text are expected, and will be known to those skilled in the art. The example screen shots provide further understanding so that one skilled in the art can make and use the present invention, but are not to be considered a limitation of the present invention or the various embodiments described and envisioned herein.

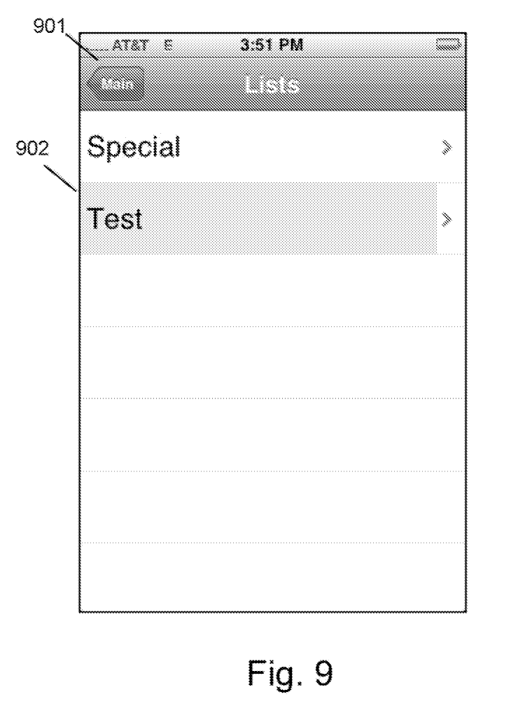

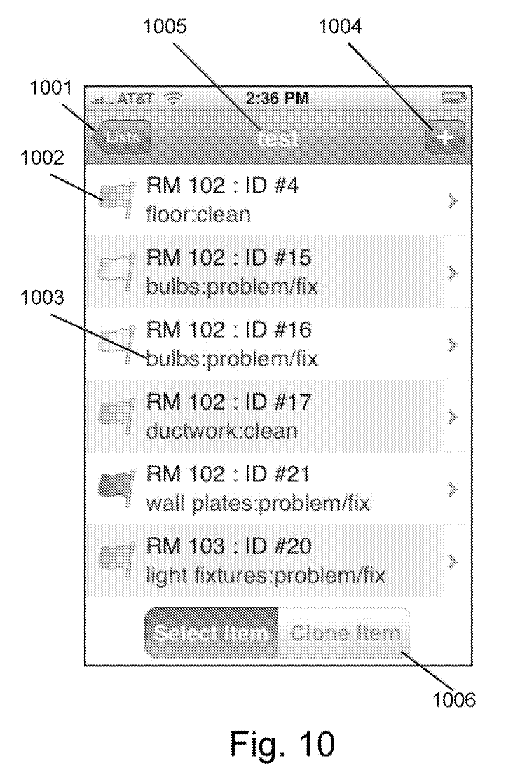

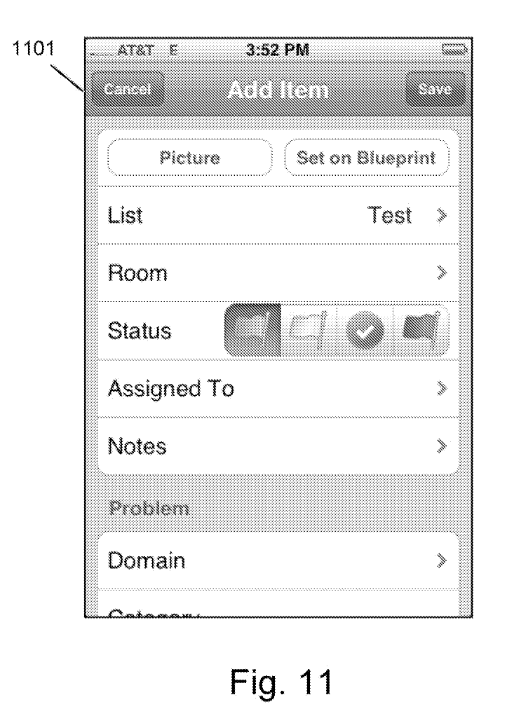

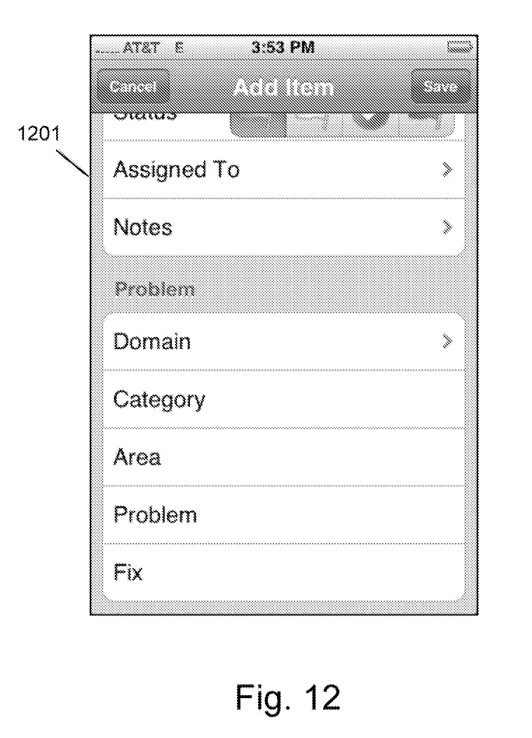

FIGS. 8 through 12 depict screenshots from a handheld device that show how a user of the system adds a new punchlist item. Turning first to FIG. 8, an exemplary main page of the mobile punchlist module is depicted. The main page provides access to many of the punchlist module's functions. A user may click on the various selections presented in the screenshot to invoke those functions. To begin to add a punchlist item, the Punchlists selection 801 is selected. The project title 802 can be seen as a heading on the top of the screen. Once Punchlists is selected, a list of the punchlists within a particular project (as evident by the project title) is displayed as shown in FIG. 9. The Main icon 901 takes a user back to the main page, as depicted in FIG. 8. To select a punchlist that a user wants to add a punchlist item to, the punchlist name 902 is selected. Once a specific punchlist is selected, the list of punchlist items is displayed, as shown by way of example in FIG. 10. The Lists icon 1001 takes a user hack to the punchlists page, as shown in FIG. 9. Each punchlist item that is displayed contains a status icon 1002. The status icon may be, for example, a flag that is color coded. Red indicating a problem. Grey indicating incomplete, Gold indicating complete, and Green indicating verified. Other color codes may also be used. Each punchlist item has a description 1003. By clicking the + icon 1004, a punchlist item can be added. A project name 1005 is provided at the top of the screen. To duplicate an item, one selects the Clone Item icon 1006 and then the punchlist item the user wants to duplicate. FIG. 11 is a screenshot example of adding an item in the mobile punchlist module. Adding a punchlist item includes entry of the project name, punchlist name, location, assignment information notes, as well as options of adding a digital picture to the punchlist item and setting the punchlist item on a blueprint. FIG. 12 shows more of the screen depicted in FIG. 11.

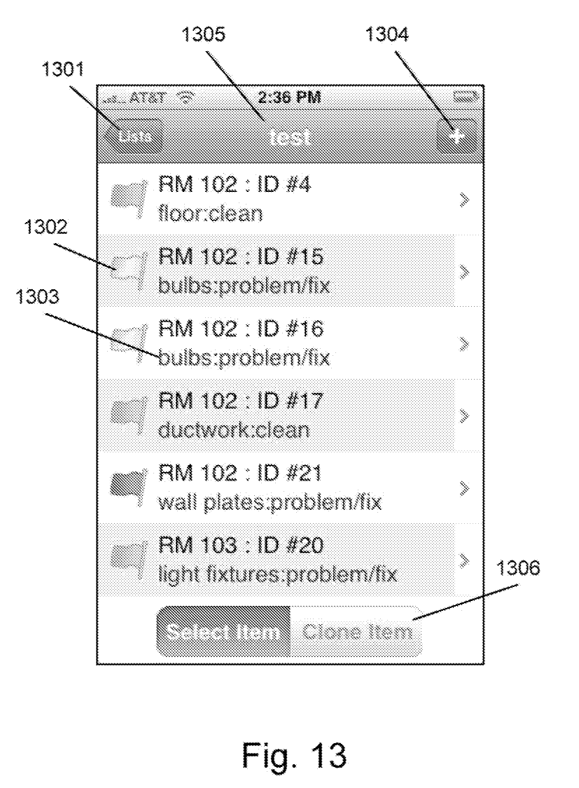

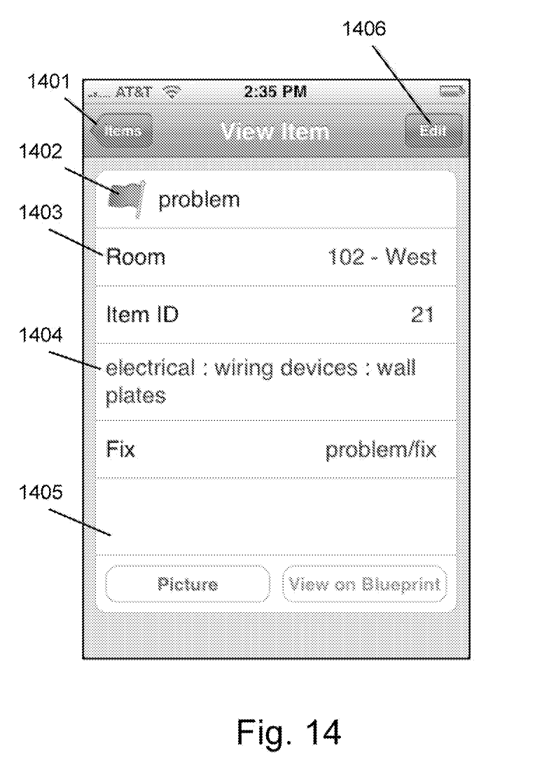

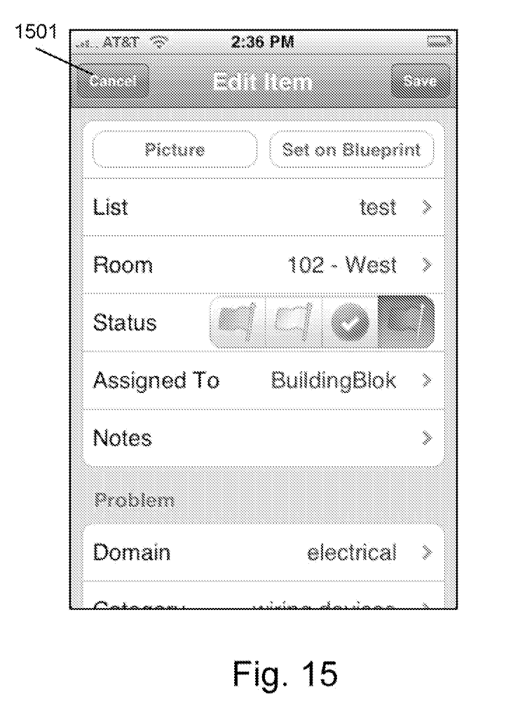

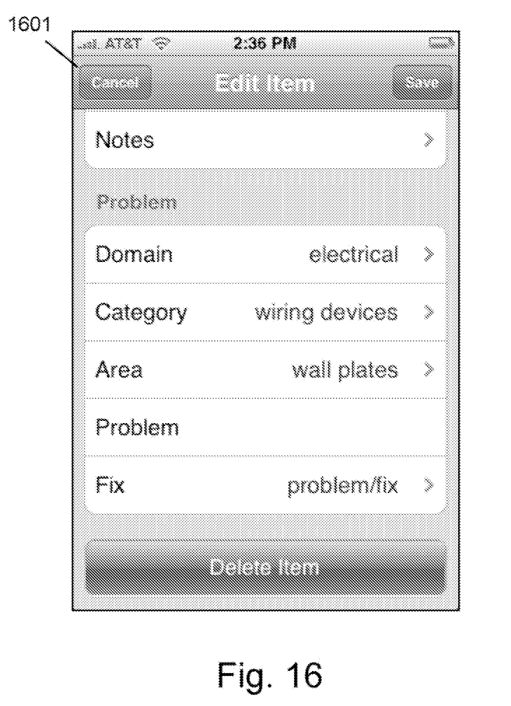

FIGS. 13-16 depict screenshots of editing a punchlist item in the mobile punchlist module. In FIG. 13, a page showing a list of punchlist items is depicted. The Lists icon 1301 will return a user hack to the punchlists page, as depicted in FIG. 9. Each punchlist item that is displayed contains a status icon 1302. The status icon may be, for example, a flag that is color coded. Red indicating a problem. Grey indicating incomplete. Gold indicating complete, and Green indicating verified. Each punchlist item has a description 1303. By clicking the + icon 1304, a punchlist item can be added. A project name 1305 is provided at the top of the screen. To duplicate an item, one selects the Clone Item icon 1306 and then the punchlist item the user wants to duplicate. FIG. 14 shows a View Item page that gives the user an overview of a specific punchlist item. The Items icon 1401 returns the user back to the punchlist items page, as shown in FIG. 13. The status of the specific punchlist item is shown by way of an indicator 1402 that may include a text label. The location of the punchlist item 1403 is displayed, as well as a description of the punchlist item 1404. A notes field 1405 is also provided. Should a user wish to edit the punchlist item, the Edit icon 1406 is selected. FIG. 15 shows the Edit item screen that allows a user to edit a punchlist item. Fields that can be edited include, but are not limited to, list, room, status, assigned to, noted, domain, category, area, problem, fix, and the like. The item can also be deleted from this screen. Pictures can be imported and attached to the punchlist item, and the punchlist item can be set on an electronic blueprint. FIG. 16 depicts the lower half of the screen depicted in FIG. 15.

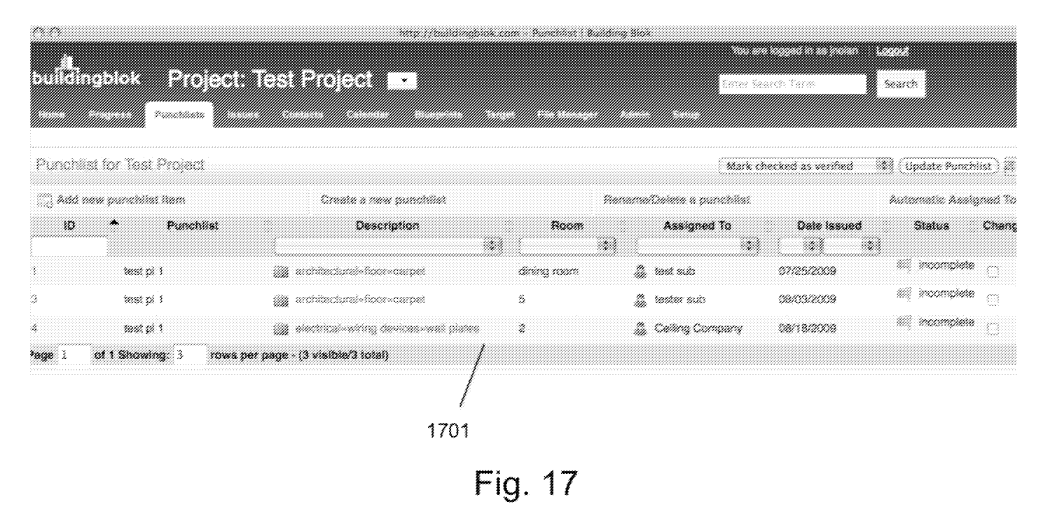

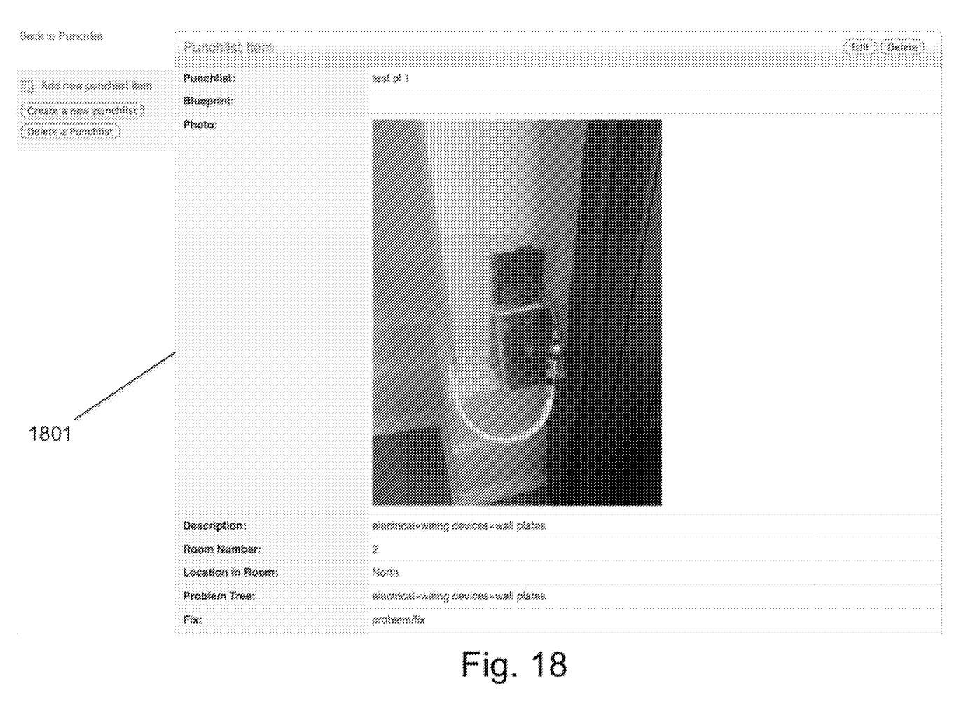

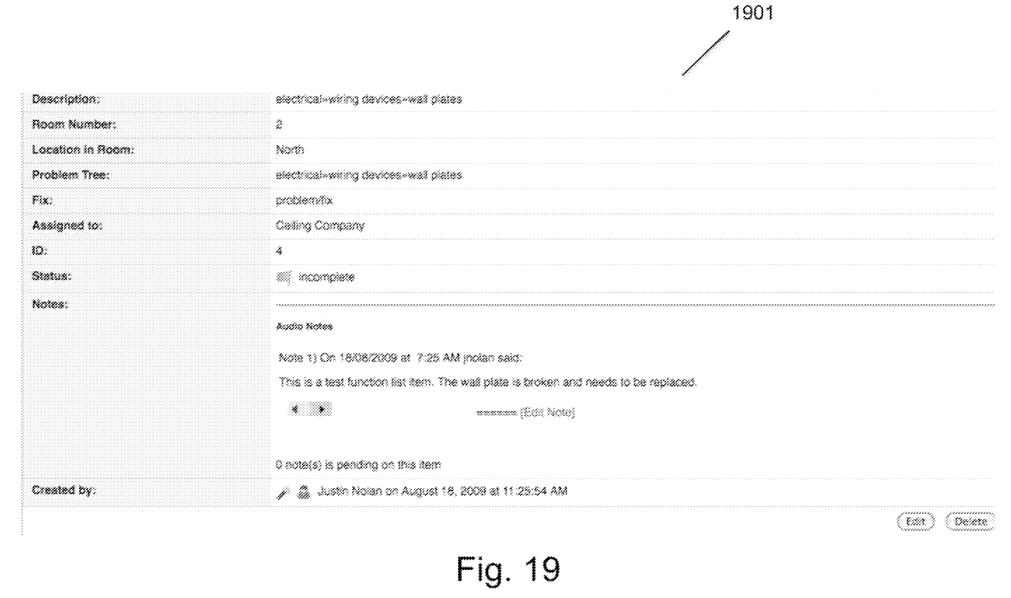

The system architecture is such that functionality is also provided by way of a website. The website may include secure or limited access. Examples of punchlist items displayed by way of a website and the punchlist module are provided by way of FIGS. 17, 18, and 19. FIG. 17 is a screenshot of an exemplary web page of punchlist items in the punchlist module. As can be seen, the project name is provided along with punchlist items including ID, punchlist name, description, room, assigned to, date issued, status, change, and the like. Other functions accessible from this screen include creating a new punchlist, renaming, or deleting a punchlist, and automatically assigning a punchlist item. FIG. 18 is a screenshot of an exemplary web page of a punchlist item having a digital image in the punchlist module. The digital image may be a photo or, in some embodiments of the present invention, a video, and includes a description, and locator details. The punchlist item is contained under a punchlist. The punchlist item can be edited or deleted, a new punchlist can be created, or an existing punchlist can be deleted. FIG. 19 is a screenshot of the bottom of the screen in FIG. 18. The punchlist item details further include a description, room number, location in room, a problem tree, a fix, assigned to, an ID number, a status, notes, and tracking information such as created by and last modified by.

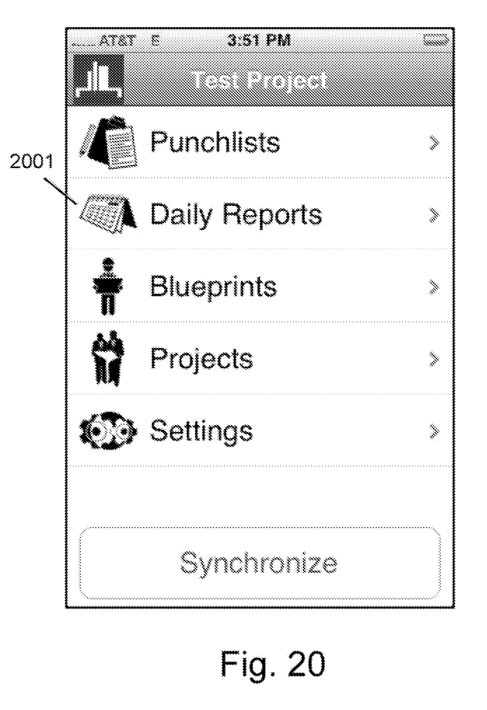

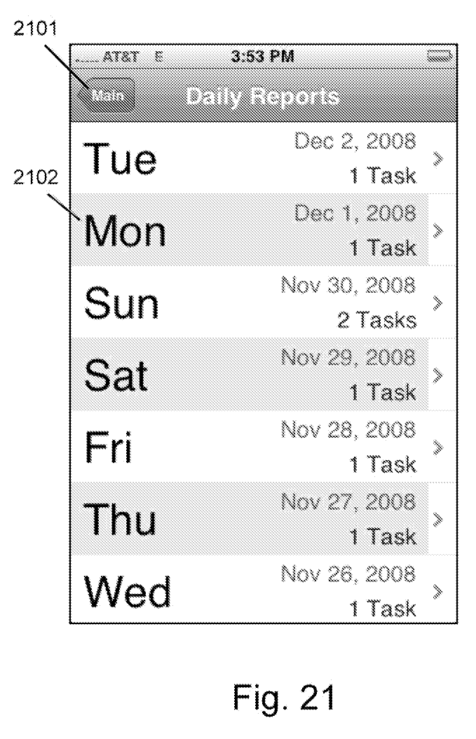

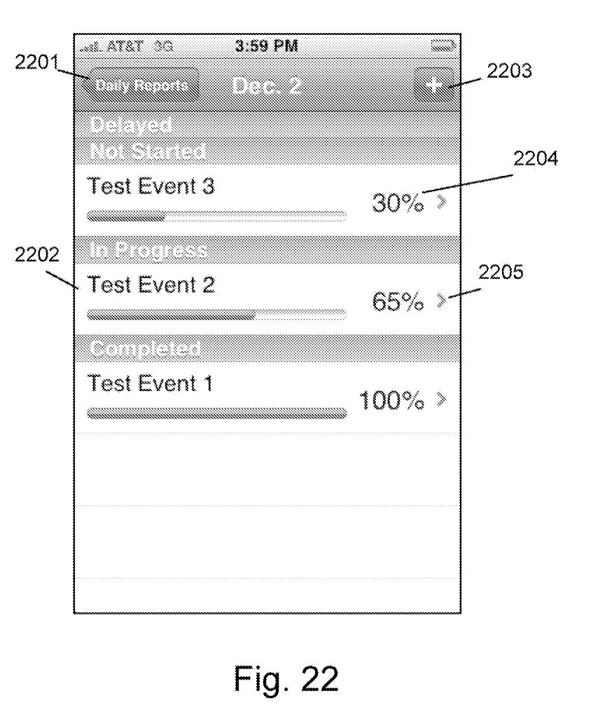

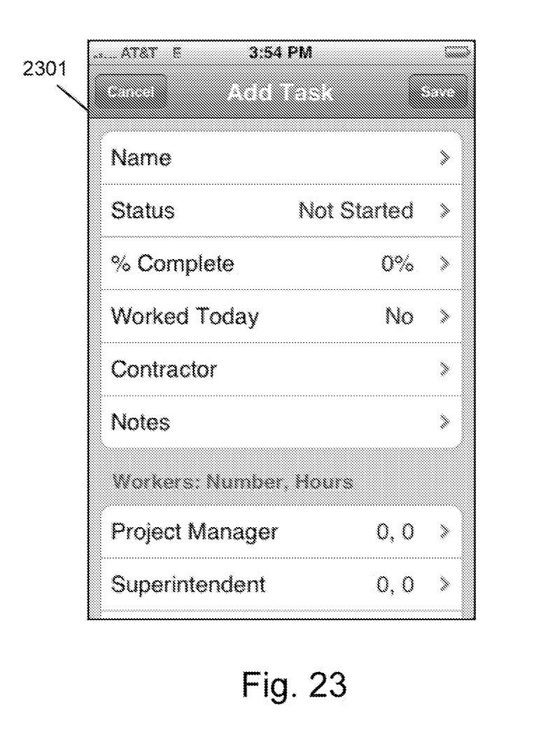

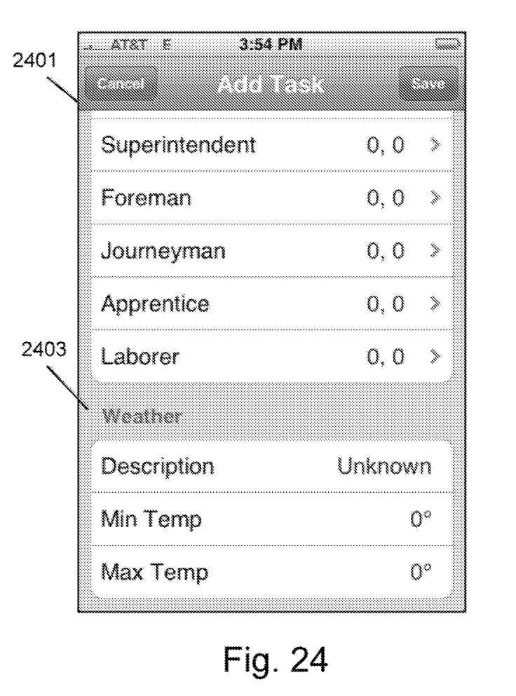

FIGS. 20-24 depict screenshots of adding a daily reports task in the mobile punchlist module. Turning to FIG. 20, an exemplary main page of the mobile punchlist module is depicted. The main page provides access to many of the punchlist module's functions. A user may click on the various selections presented in the screenshot to invoke those functions. To begin to add a daily reports task, the Daily Reports selection 2001 is selected. The project title can be seen as a heading on the top of the screen. Once Daily Reports is selected, a list of the daily report tasks organized by days of the week are displayed as show in FIG. 21. The Main icon 2101 takes a user back to the main page, as depicted in FIG. 20. To select to view daily report tasks on a particular day, the specific day 2102 is selected. The daily report main page can be seen in FIG. 22. The Daily Reports icon 2201 takes a user back to the daily reports page of FIG. 21. Task titles 2202 can be seen, as well as percentage complete 2204 for each task. To add a daily report task, the + icon 2203 is selected. Selecting the symbol 2205 selects a task to open. FIG. 23 is a screenshot example of adding a daily report task. Icons such as Save and Cancel are used once data fields are populated by the user. Task data including task name, status, percentage complete, worked today, contractor, notes, project manager, and superintendent, is entered by the user. FIG. 24 is a screenshot of the bottom of the screen in FIG. 23, and shows additional data fields including foreman, journeyman, apprentice, laborer, as well as weather information. Current weather information is important to many construction related activities, and weather information may be obtained from various sources, including the National Weather Service, local television and radio stations, and internet sites.

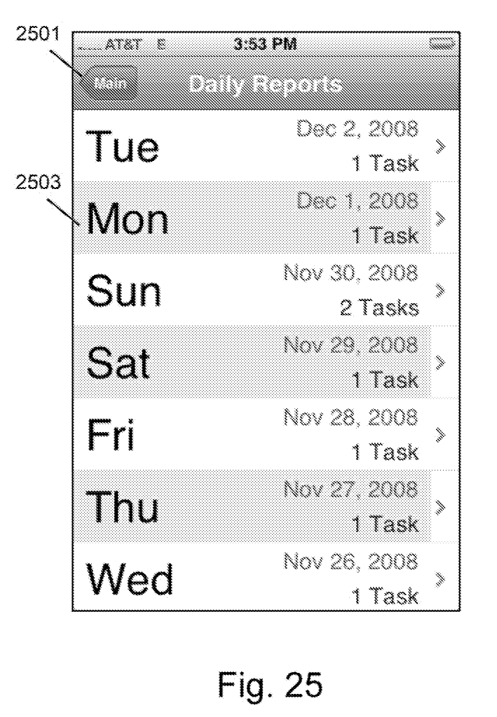

FIGS. 25-28 depict screenshots of editing a daily reports task in the mobile punchlist module. Turning to FIG. 25, a screenshot of an exemplary daily report task list of the mobile punchlist module is depicted.

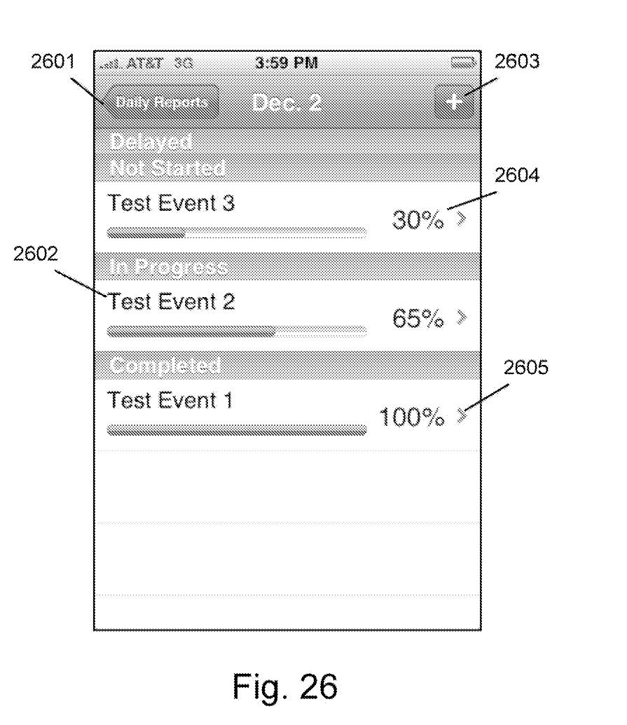

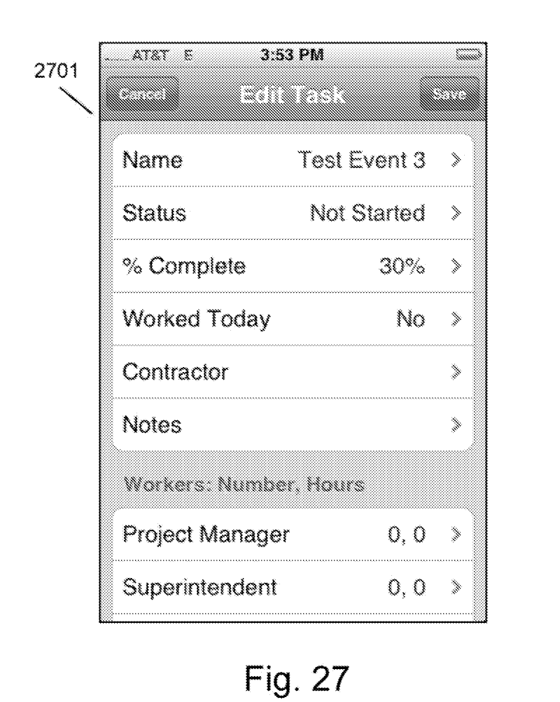

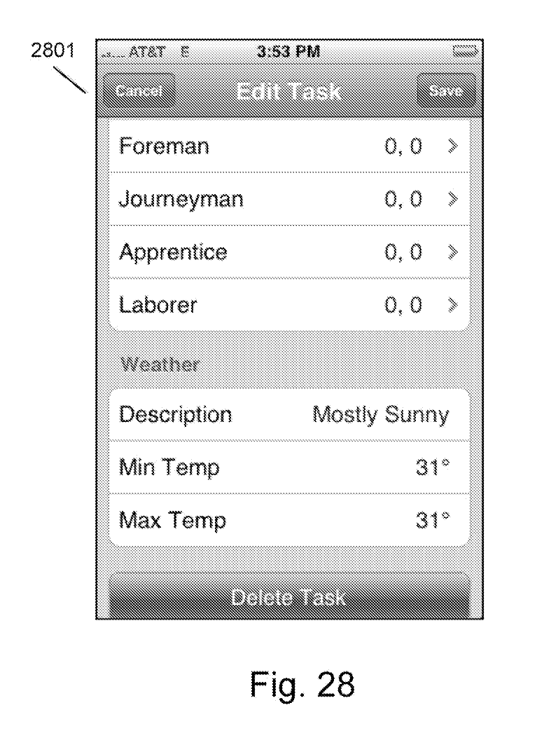

The Main icon 2501 takes a user back to the main page, as depicted in FIG. 20. To select to view daily report tasks on a particular day, the specific day 2502 is selected. The daily report main page can be seen in FIG. 26. The Daily Reports icon 2601 takes a user back to the daily reports page of FIG. 25. Task titles 2602 can be seen, as well as percentage complete 2604 for each task. To add a daily report task, the icon 2603 is selected. Selecting the symbol 2605 selects a task to open. FIG. 27 is a screenshot example of editing a daily report task. Icons such as Save and Cancel are used once data Fields are populated by the user. Task data including task name, status, percentage complete, worked today, contractor, notes, project manager, and superintendent, can be edited by the user. Editing is initiated by clicking on the fields the user wishes to edit. FIG. 28 is a screenshot of the bottom of the screen in FIG. 27, and shows additional data fields including foreman, journeyman, apprentice, laborer, as well as weather information. Current weather information is important to many construction related activities, and weather information may be obtained from various sources, including the National Weather Service, local television and radio stations, and internet sites.

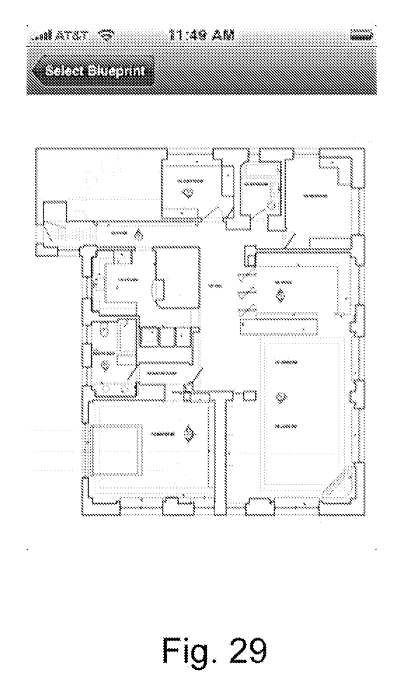

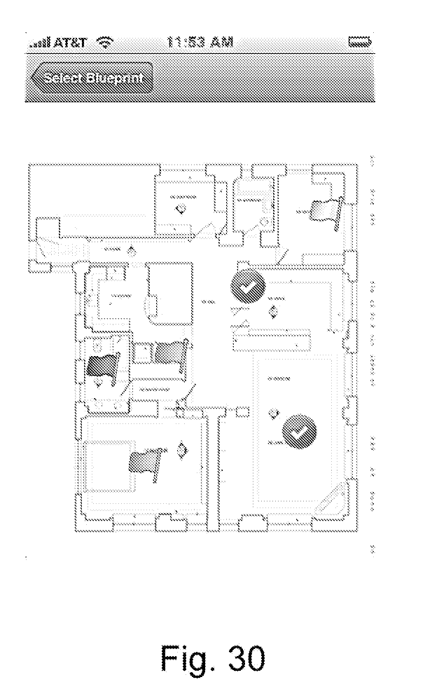

Turning to FIGS. 29 and 30, screenshots depicting blueprint navigation in the mobile blueprint navigation module are depicted. The blueprint navigation module and the mobile blueprint navigation module provide visualization of electronic blueprints on both a handheld device and an internet or network connected computer. The electronic blueprints may be in any number of electronic formats such as computer aided design formats such as Autodesk® Autocad®, ProEngineer®, Adobe® Acrobat®, as well as image formats such as jpeg, png, bmp, tiff, and the like. FIG. 29 depicts such an electronic blueprint displayed on a handheld device. The Select Blueprint icon at the top allows a user to choose a blueprint that has been loaded in the system. The blueprint can be navigated using pan and zoom functions on the handheld device or computer. In addition, the punchlist overlay module of the present invention allows for presentation of status indicators and other punchlist information directly on the electronic blueprint, as depicted in FIG. 30. Such interoperability between electronic blueprints and punchlists is provided on both handheld devices and computers.

It is, therefore, apparent that there has been provided, in accordance with the various to objects of the present invention, a system and method for coordinating building, and construction activities. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, drawings and claims herein.

What is claimed is:

1. A computer based system for coordinating building and construction activities comprising:
a server having a punchlist module for creating and managing electronic punchlists, a blueprint navigation nodule that stores and displays electronic blueprints, and a punchlist overlay module coupled to both the punchlist module and the blueprint navigation module for tagging a punchlist in the punchlist module to a location on an electronic blueprint contained in the blueprint navigation module;
at least one handheld device having a mobile punchlist module, a mobile blueprint navigation module, and a mobile punchlist overlay module coupled to both the mobile punchlist module and the mobile blueprint navigation module; and a connection between the server and the at least one handheld device for data transfer between the server and the at least one handheld device.

2. The system for coordinating building and construction activities as recited in claim 1 further comprising a contracts module.

3. The system for coordinating, building and construction activities as recited in claim 1 further comprising a specifications module.

4. The system for coordinating building and construction activities as recited in claim 1 further comprising a scheduling module.

5. The system for coordinating building and construction activities as recited in claim 1 further comprising an issues module.

6. The system for coordinating building and construction activities as recited in claim 1 further comprising a mobile issues module.

7. The system for coordinating building and construction activities as recited in claim 1 further comprising a request for information management module.

8. The system for coordinating building and construction activities as recited in claim 1 further comprising a change order module.

9. The system for coordinating building and construction activities as recited in claim 1 further comprising a reporting module.

10. The system for coordinating building and construction activities as recited in claim 1 further comprising an email alerts module.

11. The system for coordinating building and construction activities as recited in claim 1 further comprising digital media operatively connected to the electronic punchlist.

12. A computer implemented method for coordinating building and construction activities, said method comprising:
adding an electronic blueprint to a blueprint navigation module that operates on an electronic device;
creating an electronic punchlist on an electronic device;
tagging the created electronic punchlist to a location on an electronic blueprint;
adding contents to the electronic punchlist using an electronic device; and
managing and updating the electronic punchlist from an electronic device.

13. The computer implemented method for coordinating building and construction activities of claim 12 further including the step of electronically transferring the contents of the electronic punchlist into an electronic report.

14. The computer implemented method for coordinating building and construction activities of claim 12 wherein the electronic device is a computer.

15. The computer implemented method for coordinating building and construction activities of claim 12 wherein the electronic device is a handheld computing device.

16. The computer implemented method for coordinating building and construction activities of claim 12 further including the step of establishing a network of electronic devices for geographically disperse creating, managing, and updating of electronic punchlists.

17. The computer implemented method for coordinating building and construction activities of claim 12 further including the step of creating a digital media file that is electronically linked to the electronic punchlist.

18. A computer based punchlist system for managing building and construction activities comprising:
a server having, a punchlist module for creating and managing electronic punchlists;
at least one handheld device having a mobile punchlist module;
a connection between the server and the at least one hand held device for data transfer between the server and the at least one handheld device;
a first sync function residing on the server for mapping punchlist data between the server and the at least one handheld device; and
a second sync function residing on the at least one handheld device for mapping punchlist data between the at least one handheld device and the server.

19. The computer based punchlist system as recited in claim 18, further comprising digital media operatively connected to said punchlist data.

20. The computer based punchlist system as recited in claim 18, further comprising a reporting module.
